(19) United States
(12) Patent Application Publication
(10) Pub. No.: US 2004/0162648 A1
(43) Pub. Date: Aug. 19, 2004

(54) Configurable cockpit information presentation device

(75) Inventors: Richard Bontrager, Shawnee Mission, KS (US); Scott Coleman, Kansas City, MO (US); John Whittaker, Leawood, KS (US); Keith Kurle, Lees Summit, MO (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ

(21) Appl. No.: 10/368,757

(22) Filed: Feb. 18, 2003

(51) Int. Cl. G06F 17/00

(52) U.S. Cl. 701/3; 340/945; 340/971

(57) ABSTRACT

A cockpit configuration management apparatus, method and computer program product for enabling pilot configurations of display and non-display avionics devices to be saved to a storage device, retrieved from that storage device, and optionally saved and retrieved to and from a transportable media. The cockpit configuration management, method and computer program product enable a pilot to save selected cockpit configuration preferences, so that, for example, another pilot may reconfigure the cockpit, without loss of the configuration preference information.

### FIELD OF THE INVENTION

The present invention relates to aircraft cockpit configuration management, particularly to devices and methods for the configuration management of all cockpit electronic hardware and instruments, including electronic avionic subsystem displays utilized in the cockpit of an aircraft, such as a primary flight display (PFD), multi-function display (MFD), and a Head Up Display (HUD), and preferences of individual pilots with regard to display device defaults, frequently used flight plans, preferred radio frequencies, and user-defined way-points.

### BACKGROUND OF THE INVENTION

Commercial and military aircraft are provided with a variety of electronic avionic subsystems, including navigation equipment, radios, gauges, and flight computers suited to control the aircraft. Other electronic avionic subsystems provide information about the vertical aircraft position relative to barometric altitude or a vertical flight path relative to a ground reference point (runway threshold) or predefined waypoint. Electronic avionic subsystems having display capabilities provide situational awareness of the aircraft to the pilot during flight by displaying such information on conventional flight displays, such as a primary flight display (PFD), multi-function display (MFD) or a Head Up Display (HUD), independent of display technology, e.g. cathode ray tube (CRT) display and liquid crystal display (LCD), and other flight display technologies. Other avionics devices include cockpit instrument displays that provide digital or graphic information read-outs of situational awareness information. The displays may provide representations of old technology mechanical indicators such as pointers on a dial or scale or a moving tape display or modern 3D symbology.

One type of display described by Konicke, et al. in U.S. Pat. No. 4,860,007, entitled INTEGRATED PRIMARY FLIGHT DISPLAY, issued Aug. 22, 1989, which is incorporated in its entirety herein by reference, is an integrated primary flight display (PFD) apparatus that provides coordinated information within minimum eye scan distances using a cathode ray tube (CRT) generated presentation having a centered electronic attitude direction indicator with indicia thereadjacent and pointers centrally directed, and an arcuate shaped heading indicator that is expanded in angular extent for enhanced sensitivity.

Another type of PFD described by Snyder, et al. in U.S. Pat. No. 6,320,579, entitled COCKPIT DISPLAY HAVING 3D FLIGHT PATH ERROR SYMBOLOGY, issued Nov. 20, 2001, which is incorporated in its entirety herein by reference, generates a 3-dimensional (3D) symbology indicative of the aircraft situational information, wherein the 3D symbology includes a 3D vertical path error symbol and a 3D lateral flight path error symbol. Several 3D altitude symbols are also displayed which collectively render a 3D representation of the aircraft situation. The 3D symbology enhances the pilot's awareness of the aircraft situation to accurately control the aircraft, and to easily to monitor the performance during manual and automatic flight.

Yet another type of aircraft display is described by Charles L. Hett in co-pending U.S. patent application Ser. No. 10/052,716 (Attorney Docket No. H000 1799), entitled STIMULATED VISUAL GLIDESLOPE INDICATOR ON AIRCRAFT DISPLAY, filed Jan. 17, 2002, which is incorporated in its entirety herein by reference, in which an aircraft receives an instrument landing system (ILS) radio beam and generates a visual glide slope on an aircraft PFD or HUD that a pilot can safely follow during an instrument approach to the runway. The ILS radio beam is detected by an electronic avionic subsystem on board the aircraft and the display provides lateral, along course, and vertical guidance to a pilot attempting to land at an ILS equipped airport. The aircraft-display as described by Hett further provides a simulated airport lighting aid, such as a Visual Approach Slope Indicator (VASI) system or one of the Precision Approach Path Indicator (PAPI) two- and four-light systems for providing visual glide slope guidance when an airport lacks both an ILS radio beam and lighting aids.

Modern flight displays, such as PFDs, MFDs, and HUDs, thus have significant display capabilities and can be programmed to accommodate a pilot's personal configuration and operational display preferences. Other cockpit avionics devices have smaller instrument display capabilities that can be programmed to lesser extents. Furthermore, a single air carrier typically has a fleet of similar, but not identical aircraft with similar, but not identical cockpit configurations. These modern aircraft, and in particular modern commercial aircraft, are generally by a number of different pilots, with the pilots flying a number of different aircraft. This constant shuffling requires each pilot to program the PFD, MFD, HUD and other cockpit instrument display devices with his or her personal configuration and operational display preferences upon taking command of the aircraft.

FIG. 1 illustrates a highly integrated cockpit 1, wherein numerous pieces of aircraft situational awareness information from numerous information sources, collectively indicated at 3, are accumulated via a common data bus 5. The information sources 3 include by example and without limitation an aircraft situation information source 3a providing information such as indicated airspeed, indicated airspeed rate, flight path and glideslope data, as well as other aircraft situation information; a map information source 3b providing information such as navigation map information, weather map in information, traffic map and terrain map information, as well as other map information; a radio frequency information source 3c providing information such as communications frequency information, navigation frequency information, DME frequency and transponder frequency information and other radio frequency information; various engine information sources 3d; various cabin management information sources 3e; and various other aircraft situation information sources commonly present in the cockpit and coupled to provide aircraft situation information on the data bus 5. One or more display devices, such as the a PFD 10, a MFD 11, a HUD 12, are able to receive and consolidate situational awareness information from the information sources 3 via the data bus 5 and either display the information directly or manipulate the information into a presentation suitable for display.

At least some of the aircraft situational awareness information sources 3 are embodied as conventional cockpit instruments manufactured as self-contained units each containing a combination of transmitters, receivers, sensors, signal conditioners, computing resources, and other instrumentation that provide a unique avionics capability. These cockpit instruments 3 have the capability to share information via conventional I/O devices coupled to the common data bus 5. While these cockpit instruments 3 often provide numerous pilot-selectable operational and display options, collectively expressed as a “configuration,” available cockpit space limits these instruments 3 to small front panels that must accommodate an information display and one or more input devices, e.g., knobs and buttons, for inputting pilot configuration selections. Thus, these cockpit instruments 3 typically lack sufficient front panel size to operate as a significant display resource. Modern flight displays, such as the PFD 7, MFD 9 and HUD 11, evolved to consolidate information from the mass of instruments 3 in the cockpit and other information sources 3 available on the data bus 5 and display the information in a manageable presentation form.

The display devices PFD 10, and MFD 11, HUD 12 and other cockpit instrument display devices are connected to the common data bus 5. As FIG. 1 suggests, the on-screen area required to display all of the information available from the data bus 5 may potentially, exceed the available screen area on the one or more display devices 10, 11, 12. Generally, the information to be displayed must be multiplexed, overlaid, or otherwise managed to enable the pilot to select which information is presented at any time and in what format.

The operational complexity of non-display avionics devices can be as overwhelming to pilots as the complexity of the available information. A traditional solution to this complexity is enabling each of the avionics devices to have many operational and display options according to personal configuration preferences of the individual pilot that, once set by the pilot, generally remain unchanged. Current art enables pilots to configure the appearance and presentation of displayed information much the same way as a user of a personal computer is able to configure the appearance and presentation of displayed information. The flight management burden on a pilot can be significant. The display options that a pilot selects can potentially unburden the pilot and enhance both the situational awareness of the pilot and the overall safety of flight.

### SUMMARY OF THE INVENTION

The present invention is an apparatus and method that overcomes the flight management burden presented by the prior art display options provided for displaying the many modes and options available for modem avionics devices. The present invention provides an apparatus and method for enabling pilot configurations for display and non-display avionics devices to be saved to a storage device, retrieved from that storage device, and optionally saved and retrieved to and from a transportable media. The apparatus and method of the invention enables a pilot to save selected cockpit configuration preferences, so that, for example, another pilot may reconfigure the cockpit, without loss of the configuration preference information.

The apparatus and method of the invention enable a pilot to restore his cockpit configuration preferences, so that, for example, he may configure the cockpit after another pilot has reconfigured the cockpit according to a different set of configuration preferences.

The apparatus and method of the invention enables a pilot to transport his cockpit configuration preferences between one aircraft and another.

The apparatus and method of the invention furthermore enables a fleet manager to configure all aircraft in a fleet to identical cockpit configuration modes.

The present invention provides an apparatus and method for storing and retrieving a pilot's personal configuration preferences to and from an on-board storage device.

The present invention provides a mechanism for retrieving the previously stored preferences of an individual pilot, thus enabling the entire cockpit to conform to the preferences of that pilot.

The present invention provides an apparatus and method for transporting a pilot's personal configuration display preferences between aircraft and programming the aircraft with such preferences.

According to one aspect of the invention, the invention provides an avionics system having a source of electronic data signals conveying aircraft situational awareness information; a device structured for storing one or more avionics configuration selections, and a plurality of avionics being coupled for receiving one or more of the electronic data signals, each of the avionics being coupled for retrieving the one or more configuration selections and having one or more operational and display configuration options that are susceptible to control by the one or more avionics configuration-selections. Each avionics unit is further structured for receiving one or more of the configuration selections as input via one or more configuration selectors, The avionics system further includes a data bus coupled to interface between the source of electronic data signals, the device for storing avionics configuration selections, and the plurality of avionics. Also, each of the avionics is further structured for publishing to the data bus one or more of the configuration selections received as input via the one or more configuration selectors.

According to another aspect of the invention, the device for storing avionics configuration selections may also include a transportable medium, such as a computer diskette, a flash card, or a down-loadable internet file.

According to another aspect of the invention, the one or more configuration selections are retrieved from the storage device as a function of a security code, such as a coded password; identification code, name, employee number, or other personal identifying information specific to an individual pilot or a cadre of pilots.

According to yet another aspect of the invention, the invention provides a method for configuring an avionics device, the method including initially establishing one or more configuration preferences for configuring an avionics device that is susceptible to configuration control by the one or more avionics configuration selections; storing the one or more configuration preferences; recalling the one or more stored configuration preferences, loading the one or more configuration preferences into the avionics device; and configuring the avionics device as a function of the one or more configuration preferences.

According to another aspect of the invention, the method of the invention also includes publishing the initially established configuration preferences to a data bus coupled between the avionics device and a device for storing the configuration preferences.

According to another aspect of the invention, configuring the avionics device also includes configuring one or more of a plurality of selectable operational and display configuration options.

According to another aspect of the invention, establishing one or more configuration preferences also includes selecting one or more of a plurality of selectable operational and display options.

According to another aspect of the invention; storing the one or more configuration preferences also includes storing the one or more configuration preferences on a transportable medium.

According to another aspect of the invention, the method of the invention includes storing the one or more configuration preferences in non-volatile storage as a function of a security code.

According to another aspect of the invention, the method of the invention includes editing one or more of the configuration preferences and storing the edited configuration preferences as part of a preference set of configuration preferences.

According to another aspect of the invention, the method of the invention includes configuring one or more of an appearance and a presentation of situational awareness information displayed on the avionics device.

According to still another aspect of the invention, the invention provides a computer program product residing on a computer usable storage medium, the computer program product including a computer-usable medium having computer-readable code embodied therein for configuring a computer processor, the computer program product having computer-readable code configured to cause a computer processor to retrieve from storage on a computer-readable medium a set of instrument configuration control information for controlling one or more of an operational configuration option and a display configuration option of an avionics instrument; computer-readable code configured to cause a computer processor to configure a plurality of operational and display configuration options of an avionics instrument as a function of the retrieved set of instrument configuration control information.

According to another aspect of the invention, the computer-readable code of the invention is further configured to cause a computer processor to receive as input to an avionics device that is susceptible to configuration control by the configuration selections one or more configuration selections for configuring the avionics device. Furthermore, the computer-readable code that is configured to cause a computer processor to receive as input to an avionics device is further configured to cause a computer processor to edit the set of instrument configuration control information.

According to another aspect of the invention, the computer-readable code configured to cause a computer processor to store the configuration selections as the set of instrument configuration control information is further configured to cause a computer processor to store the edited set of instrument configuration control information.

According to another aspect of the invention, the computer-readable code is further configured to cause a computer processor to store on the computer-readable medium the received one or more configuration selections as the set of instrument configuration control information.

According to another aspect of the invention, the computer-readable code configured to cause a computer processor to store on the computer-readable medium the received one or more configuration selections as the set of instrument configuration control information is further configured to cause a computer processor to store the set of instrument configuration control information on a transportable computer-readable medium. The computer-readable code that is configured to cause a computer processor to store on the computer-readable medium the received one or more configuration selections as the set of instrument configuration control information is further configured to cause a computer processor to store the set of instrument configuration control information as a function of a security code.

According to still another aspect of the invention, the computer-readable code that is configured to cause a computer processor to configure a plurality of operational and display configuration options of an avionics instrument as a function of the retrieved set of instrument configuration control information includes computer-readable code that is configured to cause a computer processor to configure one or both of an appearance and a presentation of situational awareness information displayed on the avionics device.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a highly integrated cockpit wherein numerous pieces of information from numerous information sources are accumulated via a common data bus and one or more display devices are coupled to receive information from the data bus and display the information directly or manipulate the information into a presentation suitable for display; and

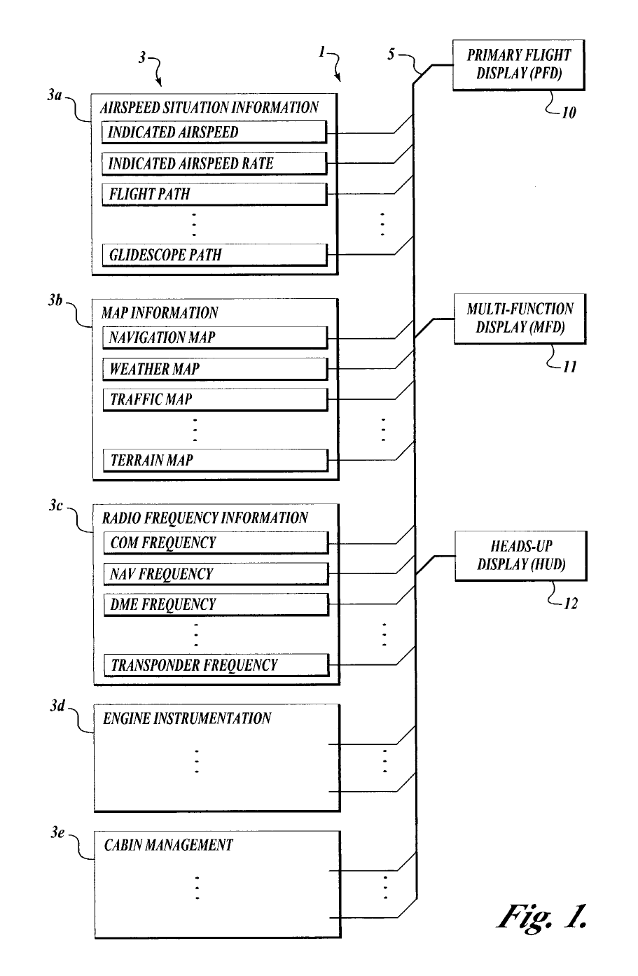

FIG. 2 illustrates a functional block diagram of an avionics subsystem in which one or more electronic avionic subsystem displays are functionally coupled to and interfaced with an instrument suite of conventional aircraft situational awareness information devices that are coupled to provide aircraft situational awareness information to the displays via a conventional aircraft data bus or another suitable means for providing real-time electronic data signals.

### DETAILED DESCRIPTION OF PREFERRED EMBODIMENT

In the Figures, like numerals indicate like elements.

According to the devices and methods of the present invention, a plurality of individual option preferences are available for managing the configuration of electronic hardware devices and instruments in an aircraft cockpit, including electronic avionic subsystem displays utilized in the cockpit of an aircraft, such as a primary flight display (PFD), multi-function display (MFD), and a Head Up Display (HUD), and preferences of individual pilots with regards to display device defaults, frequently used flight plans, preferred radio frequencies, and user-defined way-points. Cockpit management configuration option preferences are stored as a “Preference Set” of individual configuration selections. The preference set of configuration selections is a subset of all the valid operational and display options operable by the one or more of the cockpit electronic hardware devices and instruments.

According to one embodiment of the device and methods of the present invention, a “Preference Set” of individual configuration selections is stored as a plurality of individual operational and display option preference information for configuring the “Configuration,” i.e., appearance and presentation, of information displayed by one or more avionic subsystems. The preference set of configuration selections is a subset of all the valid operational and display options operable by the avionic subsystem, i.e., all the operational and display options presentable by the cockpit displays devices.

The invention is particularly directed to those avionics subsystems having significant display capabilities, e.g., primary flight displays (PFDs), multi-function displays (MFDs) and Head Up Displays (HUDs). The invention's “Preference Set” of individual configuration selections captures all data necessary for configuring the essential operation and display preferences of a particular avionics subsystem. According to the invention, the “Preference Set” of information is stored to a designated “Preference Storage Device” that stores and retrieves the “Preference Set” of operational and display option information as a function of a security code, such as a coded password. According to one embodiment of the invention, the “Preference Set” of individual configuration preference information is optionally saved on a transportable computer readable medium, thereby enabling the preference information to be transported between different aircraft cockpits. The pilot uses the security code to recall the preference information from the “Preference Storage Device,” which causes the entire cockpit to be reconfigured to reflect the preferences of the particular user pilot.

The “Preference Storage Device” is structured to store and retrieve the configuration preferences of a number of different pilots as a function of different coded passwords, so that the cockpit appears to “remember” the preferences of any pilot who takes command. In addition, one or more default configurations may be stored in the preference storage device of each aircraft in a fleet so that a fleet manager may configure all aircraft in a fleet to have identical cockpit configurations, or permit the individual pilots to select from a menu of a few different cockpit configurations.

The security code, i.e., the coded password, either alone or in combination with other security measures, prevents unauthorized manipulation of a pilot's personal preferences using the Preference Storage Device. The Preference Storage Device also includes security features that support fleet operations where, for example, an air carrier securely establishes a default cockpit configuration for an entire fleet of aircraft.

The invention is an apparatus for automatically storing and retrieving configuration information, in accordance with a set of user preferences, for a variety of cockpit instruments, including number of computer displays. Such configuration information embodies the operating and display options for an entire array of cockpit electronic hardware devices and avionics instruments, consistent with the preferences of an individual pilot. The apparatus includes a Preferences Storage Device, which may be wholly contained, as a subset, within another cockpit instrument, e.g. a PFD or MFD, or a separate memory device, and an optional transportable references storage medium, e.g. a computer diskette, a flash card, or a down-loadable internet file, having the pilot's personal Preference Set stored thereon. The apparatus assumes conventional data bus connections to the majority of instruments typically available in the cockpit. The method of the invention includes initially establishing and storing a number of configuration preferences followed by loading the previously stored configuration preferences, using those preferences to configure the appearance and presentation of some or an entire array of cockpit instruments. Optionally, the method includes editing the configuration preferences, and saving the preference changes to be restored later. The invention thus provides for a cockpit that is highly customized for an individual's preferences.

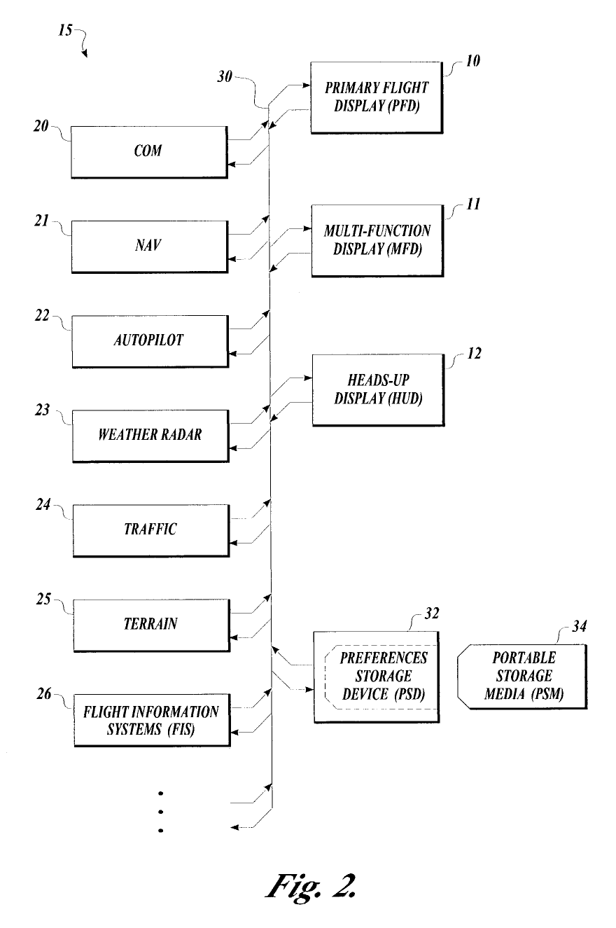

FIG. 2 illustrates a functional block diagram of an avionics subsystem in which one or more electronic avionic subsystem displays, such as a PFD 10, a MFD 11 and a HUD 12, are functionally coupled to and interfaced with various aircraft electronics. Outputs of an instrument suite, shown generally at 15 and including a plurality of conventional aircraft situational awareness information devices 20 through 26, are coupled to provide aircraft situational awareness information to the PFD 10, MFD 11 and HUD 12 via a conventional aircraft data bus shown generally at 30 or another suitable means for providing real-time electronic data signals. The one or more display devices 10, 11, 12 receive the various aircraft situational awareness information from the sensor suite 15 via the data bus 30, processes this information, and visually displays the various information according to the preferences of the pilot in command. The display devices 10, 11, 12 thus provide information in a consistent format to provide improved situational awareness to the pilot. The consistent display format allows the pilot to quickly obtain the situational awareness of the aircraft, thereby improving the ability of the pilot to monitor the flight controls, to control the aircraft, and to respond to a problem more quickly, thereby improving the operational safety of the aircraft.

The aircraft situational awareness information signals available on the data bus 30 provide a multitude of aircraft information. For example, the instrument suite 15 includes a plurality of conventional aircraft situational awareness information devices, including: communication instruments 20, navigation instruments 21, autopilot instruments 22, weather radar instruments 23, traffic information and collision avoidance instruments 24, terrain information and collision avoidance instruments 25, Flight Information Systems (FIS) instruments 26 and other well-known and commercially available aircraft situational awareness information instruments. A detailed description of the aircraft situational awareness information signals currently available on the aircraft data bus 30 is provided by the ARINC Characteristic 429 as published by Aeronautical Radio, Incorporated of Annapolis, Md., which is incorporated by reference herein in its entirety. The sensor signals from these instruments provide the various associated aircraft situational awareness information to-pertinent computational devices that ultimately provide the indicated information for display by one of the PFD 10, MFD 11 and HUD 12 display devices.

According to the present invention, a screen portion of one or more of the avionic subsystem display devices PFD 10, MFD 11, and HUD 12 is visually observable by the pilot, and provides visual positional and situational awareness to the pilot when the pilot is manually controlling the aircraft, and when the pilot is observing the operational characteristics of the autopilot. The PFD 10 or another-display device 11, 12 provides an integrated velocity and position display (IVPD) suitable for large format displays. Practice of the present invention significantly improves situational awareness to the pilot by permitting formatting of the information displayed on the PFD 10 or another avionic subsystem display 11, 12 according to the preferences of individual pilots.

Initially, a pilot selects one or a number of configuration preferences for configuring the operational and display options of one or more of the aircraft's situational awareness information devices such as the aircraft's avionic subsystems, and particularly one or more of those avionics subsystems having significant display capabilities. Any pilot-selected operating modes, display options, or other configuration preferences for any situational awareness information devices or other electronic hardware device available on the data bus 30 may be published to the data bus as a Preference Set of configuration information, and stored by a Preference Storage Device 32, which may be a memory device contained within the avionic subsystem or a conventional on board memory device coupled for communication with the data bus 30. The Preferences Storage Device 32 is structured to permit retrieval of the preference information therefrom. The preferences are optionally saved to a transportable Preferences Storage Media 34 via the Preferences Storage Device 32, and the Preferences Storage Device 32 is structured to permit retrieval of the preference information from the Preferences Storage Media 34.

Alternatively, the Preference Storage Device 32 is an internet connection device for connecting via the World Wide Web to a remote storage device. The preferences are optionally saved to the remote storage device and retrieved therefrom via the internet connection provided by the Preference Storage Device 32.

The retrieved configuration preference information is published via the data bus 30 to each instrument and device, which are configured according to those preferences. As is well-known in the art, traditional avionics radio devices, e.g., COM 20, NAV 21, DME (not shown), ADF (not shown), and Transponder (not shown) devices, include the capability of storing a number of frequently used frequencies and of being configured for different operating modes and display options representative of a pilot's preferences. For avionics devices such as autopilots and flight directors, operating modes are treated by the invention as pilot preferences and are configured to display information on the PFD 10 or another display in a consistent format according to the preferences of an individual pilot. For weather radar, traffic sensor, and terrain sensors 23, 24, 25, pilot configuration preferences include operating mode visibility, selected scales, overlay options, icon options, and other common configuration options. As FIS 26 and future avionics sensors become available on the data bus, their appropriate pilot-selected configuration preferences can be captured and restored according to the invention by the Preferences Storage Device 32, via the data bus 30.

FIG. 2 illustrates an exemplary static view without limitation of the present invention embodied in a system block diagram including one or more configurable situational awareness information devices: electronic avionic subsystem displays PFD 10, MFD 11 and HUD 12, aircraft situation information devices 20 through 26; and Preferences Storage Device (PSD) 32, all interconnected via data bus 30. Optionally, a transportable Preferences Storage Media (PSM) 34 may interact with PSD 32.

Each display device: the PFD 10, the MFD 11 and the HUD 12, in addition to their traditional functionality, include the capability to accept input of one or more pilot-selected configuration preferences. Additional functionality traditionally residing on each of the display devices 10, 11, 12 interprets the pilot-selected configuration preferences and generates display signals for displaying the aircraft situational awareness information in accordance with the pilot-selected configuration preferences. This traditional functionality of the display devices 10, 11, 12 also includes a capability to publish the pilot-selected configuration preferences to the data bus 30 and to accept pilot-selected configuration preference information from the data bus. These pilot-selectable configuration preferences include by example and without limitation one or more of a display mode, window selections, complexity options, scale selections, overlay options, icon options, and other well-known operational and display options.

Each aircraft situational awareness information device 20 through 26, in addition to its traditional functionality, includes the capability to publish its pilot-selected configuration to the data bus 30, and to accept pilot-selected configurations from the data bus. These pilot-selected configurations include by example and without limitation an operating mode, frequency selections, complexity options, scale selections, overlay options, icon options, and other well-known operational and display options. PSD 32 includes the capability to accept pilot-selected configuration preference information from the data bus and store it to non-volatile storage. PSD 32 also includes the capability to read previously saved configuration preference information from non-volatile storage and publish that configuration preference information to the data bus. PSD 32 optionally includes the capability to save the configuration preference information to an optional transportable PSM 34.

During a power-up sequence of the avionic system, each of the avionic subsystem displays PFD 10, MFD 11 and HUD 12 and each of the aircraft situational awareness information devices 20 through 26 access the PSD 32 via the data bus 30 and attempts to retrieve stored configuration preference information. The PSD 32 attempts to read configuration preference information from the PSM 34. If a PSM 34 bearing appropriate configuration preference information is present, the preference information is read from it. If the PSM 34 is not present or if the configuration preference information is not appropriate, configuration preference information previously saved in the non-volatile storage of the PSD 32 is read. Conventional validation is conducted so that only configuration information compatible with the cockpit's instrument suite, i.e., devices 10 through 12, and 20 through 26, are presented to the pilot via the display devices 10 through 12 as “configuration options.” The pilot is then permitted to select from the list of valid and available configuration options for the cockpit. The pilot's selected configuration options are then published to each cockpit instrument, i.e., devices 10 through 12 and 20 through 26, setting them to their respective selected configurations.

At any time after the avionic system is up and running with the selected configuration options established, using the one or more input devices, e.g., knobs and buttons, for inputting pilot configuration selections the pilot can modify the configuration of any cockpit instrument, e.g., devices 10 through 12 and 20 through 26.

Additionally, at any time after the avionic system is up and running, the pilot may direct the systems via the input capabilities of the display devices 10, 11, 12 to save the current configuration as a “Preference Set” of configuration option selections to the non-volatile storage of the PSD 32, and optionally to the transportable PSM 34. Traditional computer password security techniques prevent unauthorized modifications of configurations preferences. For example, the Preference Storage Device 32 stores the configuration preference information and retrieves the information as a function of the security code which is by example and without limitation a coded password, identification code, name, employee number, or other personal identifying information specific to the user pilot or a cadre of pilots. If available, the Preference Storage Device 32 optionally stores the configuration preference information to the transportable PSM 34.

Configuration preference information saved to the PSM 34 may be removed from the PSD 32 and stored on the PSM 34 for being transported to another cockpit to configure it to the pilot's preferences.

Computer Product

In addition to being practiced as apparatus and methods, the present invention is also practiced as a computer program product for configuring an avionics device according to the method of the invention described herein. By example and without limitation, one exemplary embodiment of the computer program product of the invention provides a computer program product residing on a computer usable storage medium. The computer program product including a computer-usable medium having computer-readable code embodied therein for configuring a computer processor of the type commonly used to control the operation and display functionality of the avionics subsystems described herein. The computer program product includes computer-readable code that is configured to cause a computer processor to retrieve from storage on a computer-readable medium a set of instrument configuration control information for controlling one or more operational configuration options or display configuration options of an avionics instrument. The computer program product also includes computer-readable code that is configured to cause the computer processor to configure one or more different operational and display configuration options of an avionics instrument as a function of the retrieved set of instrument configuration control information.

The computer-readable code is further configured to cause the computer processor to receive as input to one of the avionics-devices that are susceptible to configuration control by the configuration selections one or more configuration selections for configuring the avionics device.

The computer-readable code is further configured to cause the computer processor to store on a computer-readable medium the set of configuration selections as the set of instrument configuration control information. The computer-readable medium is, for example, a non-volatile storage device resident on the aircraft or a transportable storage medium.

The computer-readable code that is configured to cause the computer processor to store the set of instrument configuration control information is optionally configured to cause the computer processor to store the set of instrument configuration control information as a function of a security code.

The computer-readable code that is configured to cause the computer processor to receive as input to an avionics device is further configured to cause the computer processor to edit the set of instrument configuration control information.

The computer-readable code that is configured to cause the computer processor to store the configuration selections as the set of instrument configuration control information is further configured to cause the computer processor to store the edited set of instrument configuration control information as the set of instrument configuration control information.

For example, the computer-readable code that is configured to cause the computer processor to store the configuration selections as the set of instrument configuration control information is further configured to cause the computer processor to store the set of instrument configuration control information on a transportable computer-readable medium.

According to one exemplary embodiment of the computer program product of the invention, the computer-readable code that is configured to cause the computer processor to configure a plurality of operational and display configuration options of the avionics instrument as a function of the retrieved set of instrument configuration control information also includes computer-readable code that is configured to cause the computer processor to configure the appearance and presentation of situational awareness information that is displayed on the avionics device.

Additional Cockpit Devices

Modern cockpit devices other than the situational awareness information instruments described above often provide numerous pilot-selectable operational and display options, also collectively expressed as a “configuration.” Cockpit devices such as the pilot's power seat, the heating/air-conditioning (HVAC) device, the pilot's headset, the cabin lighting, and the rear-view mirrors are some examples of other modern cockpit devices that provide one or more pilot-selectable operational and display options. Such devices can be programmed to accommodate a pilot's personal configuration and operational display preferences. For example, the pilot's power seat includes a control panel having one or more configuration selectors for programming the seat configuration to suit the pilot. Other cockpit devices also include control panels having one or more configuration selectors for programming one or more pilot-selectable operational and display options. The HVAC device, for example, includes one or more configuration selectors on a control panel for programming cabin atmosphere. The pilot's headset includes one or more configuration selectors on a control panel for programming volume, and the rear-view mirrors include one or more configuration selectors on a control panel for programming mirror tilt to suit the pilot. These and other cockpit devices having one or more configuration selectors on a control panel for electrically adjusting the device to suit the pilot's preferences are optionally coupled into the data bus for publishing to the data bus one or more of the configuration selections programmed by the pilot and received as input via the one or more configuration selectors. The configuration selections are stored to the Preference Storage Device 32 and optionally to the transportable Preferences Storage Media 34.

Thus the cockpit configuration is initially established in so far as each cockpit instrument and device is electronically programmable and interfaceable with the data bus for storing the pilot's configuration preferences. The cockpit configuration management is accomplished to the extent that the previously stored configuration preferences are retrievable from memory and downloaded to the different cockpit devices and instruments to configure their appearance and presentation according to the pilot's configuration preferences.

While the preferred embodiment of the invention has been illustrated and described, it will be appreciated that various changes can be made therein without departing from the spirit and scope of the invention.

What is claimed is:

1. An avionics system, comprising:
a source of electronic data signals conveying aircraft situational awareness information;
a device structured for storing one or more avionics configuration selections; and
a plurality of avionics being coupled for receiving one or more of the electronic data signals, each of the avionics being coupled for retrieving the one or more configuration selections and having one or more configuration options that are susceptible to control by the one or more avionics configuration selections.

2. The avionics system of claim 1, further comprising a data bus coupled to interface between the source of electronic data signals, the device for storing avionics configuration selections, and the plurality of avionics.

3. The avionics system of claim 2 wherein each of the avionics is further structured for receiving one or more of the configuration selections as input via one or more configuration selectors.

4. The avionics system of claim 3 wherein each of the avionics is further structured for publishing to the data bus one or more of the configuration selections received as input via the one or more configuration selectors.

5. The avionics system of claim 1 wherein the device for storing avionics configuration selections further comprises a transportable medium.

6. The avionics system of claim 1 wherein the one or more configuration selections are retrieved as a function of a security code.

7. The avionics system of claim 1 wherein the one or more configuration options that are susceptible to control by the one or more avionics configuration selections include operational and display configuration options.

8. An avionics system, comprising:
a data bus structured to carry electronic information;
an instrument suite coupled to the data bus and structured to provide electronic aircraft situational awareness information;
a plurality of conventional avionics subsystems coupled to the data bus and being interfaced with one or more instrument of the instrument suite for receiving electronic aircraft situational awareness information, each of the avionics subsystems having a display functionally structured for displaying the aircraft situational awareness information in accordance with one or more configuration selections; and
a preference storage device coupled to the data bus and structured to provide electronic information comprising a preference set of the one or more configuration selections, the preference set of configuration selections being a subset of valid configuration selections.

9. The avionics system of claim 8, further comprising a transportable storage media readable by the preference storage device and having stored thereon the preference set of configuration selections.

10. The avionics system of claim 8 wherein the preference set of configuration selections is retrievable from the preference storage device as a function of a security code.

11. The avionics system of claim 8 wherein one or more instrument of the instrument suite is structured for operating in accordance with one or more instrument configuration selections, the preference set of configuration selections further comprising the one or more instrument configuration selections.

12. The avionics system of claim 8 wherein one of the plurality of conventional avionics subsystems includes means for selecting one or more of the valid instrument configuration selections.

13. The avionics system of claim 12 wherein the preference storage device is further structured to receive and store the selected one or more of the valid instrument configuration selections such that the preference set of configuration selections further comprises the selected one or more of the valid instrument configuration selections.

14. An avionics system, comprising:
means for initially establishing one or more configuration preferences for configuring an avionics device that is susceptible to configuration control by the one or more avionics configuration selections;
means for storing the one or more configuration preferences;
means for recalling the one or more stored configuration preferences;
means for loading the one or more configuration preferences into the avionics device; and
means for configuring the avionics device as a function of the one or more configuration preferences.

15. The avionics system of claim 14 wherein the means for initially establishing one or more configuration preferences further comprises means for publishing the configuration preferences to a data bus coupled between the avionics device and a device for storing the configuration preferences.

16. The avionics system of claim 14 wherein the means for configuring the avionics device further comprises means for configuring one or more of a plurality of selectable operational and display configuration options.

17. The avionics system of claim 14 wherein the means for establishing one or more configuration preferences further comprises means for selecting one or more of a plurality of selectable operational and display options.

18. The avionics system of claim 14 wherein the means for storing the one or more configuration preferences further comprises means for storing the one or more configuration preferences on a transportable medium.

19. The avionics system of claim 14 wherein the means for storing the one or more configuration preferences further comprises means for storing the one or more configuration preferences as a function of a security code.

20. The avionics system of claim 14 wherein the means for configuring the avionics device as a function of the one or more stored configuration preferences further comprises means for editing one or more of the configuration preferences.

21. The avionics system of claim 20, further comprising means for storing the edited configuration preferences.

22. The avionics system of claim 14 wherein the means for configuring the avionics device as a function of the one or more stored configuration preferences further comprises means for configuring one or more of an appearance and a presentation of situational awareness information displayed on the avionics device.

23. A method for configuring an avionics device, the method comprising:
initially establishing one or more configuration preferences for configuring an avionics device that is susceptible to configuration control by the one or more avionics configuration selections;
storing the one or more configuration preferences;
recalling the one or more stored configuration preferences;
loading the one or more configuration preferences into the avionics device, and configuring the avionics device as a function of the one or more configuration preferences.

24. The method of claim 23, further comprising publishing the initially established configuration preferences to a data bus coupled between the avionics device and a device for storing the configuration preferences.

25. The method of claim 23 wherein configuring the avionics device further comprises configuring one or more of a plurality of selectable operational and display configuration options.

26. The method of claim 23 wherein establishing one or more configuration preferences further comprises selecting one or more of a plurality of selectable operational and display options.

27. The method of claim 23 wherein storing the one or more configuration preferences further comprises storing the one or more configuration preferences on a transportable medium.

28. The method of claim 23 wherein storing the one or more configuration preferences further comprises storing the one or more configuration preferences as a function of a security code.

29. The method of claim 23 wherein configuring the avionics device as a function of the one or more stored configuration preferences further comprises editing one or more of the configuration preferences.

30. The method of claim 29, further comprising storing the edited configuration preferences.

31. The method of claim 23 wherein configuring the avionics device as a function of the one or more stored configuration preferences further comprises configuring one or more of an appearance and a presentation of situational awareness information displayed on the avionics device.

32. A computer program product residing on a computer usable storage medium, the computer program product comprising:
computer-readable program code means for receiving electronic signals representative of one or more configuration selections for configuring an avionics device that is susceptible to configuration control by the electronic signals;
computer-readable program code means for storing the one or more configuration selections;
computer-readable program code means for recalling the one or more stored configuration selections;
computer-readable program code means for loading the one or more configuration selections into the avionics device; and
computer-readable program code means for configuring the avionics device as a function of the one or more configuration selections.

33. The computer program product of claim 32 further comprising computer-readable program code means for publishing the configuration selections to a data bus coupled between the avionics device and a device for storing the configuration selections.

34. The computer program product of claim 32 wherein the computer-readable program code means for configuring the avionics device further comprises computer-readable program code means for configuring one or more of a plurality of selectable operational and display configuration options.

35. The computer program product of claim 32 wherein the computer-readable program code means for storing the one or more configuration selections further comprises computer-readable program code means for storing the one or more configuration selections on a transportable medium.

36. The computer program product of claim 32 wherein the computer-readable program code means for storing the one or more configuration selections further comprises computer-readable program code means for storing the one or more configuration selections as a function of a security code.

37. The computer program product of claim 32 wherein the computer-readable program code means for configuring the avionics device as a function of the one or more configuration selections further comprises computer-readable program code means for editing one or more of the configuration selections.

38. The computer program product of claim 37, further comprising computer-readable program code means for storing the edited configuration'selections.

39. The computer program product of claim 32 wherein the computer-readable program code means for configuring the avionics device as a function of the one or more configuration selections further comprises computer-readable program code means for configuring one or more of an appearance and a presentation of information displayed on the avionics device.

40. A computer program product for configuring an avionics device, the computer program product comprising:
a computer-usable medium having computer-readable code embodied therein for configuring a computer processor, the computer program product comprising:
computer-readable code configured to cause a computer processor to retrieve from storage on a computer-readable medium a set of instrument configuration control information for controlling one or more of an operational configuration option and a display configuration option of an avionics instrument;
computer-readable code configured to cause a computer processor to configure a plurality of operational and display configuration options of an avionics instrument as a function of the retrieved set of instrument configuration control information.

41. The computer program product of claim 40 wherein the computer-readable code is further configured to cause a computer processor to receive as input to an avionics device of a type that is susceptible to configuration control by the configuration selections a set of one or more configuration selections for configuring the avionics device.

42. The computer program product of claim 41 wherein the computer-readable code that is configured to cause a computer processor to receive as input to an avionics device is further configured to cause a computer processor to edit the set of instrument configuration control information.

43. The computer program product of claim 42 wherein the computer-readable code configured to cause a computer processor to store the configuration selections as the set of instrument configuration control information is further configured to cause a computer processor to store the edited set of instrument configuration control information.

44. The computer program product of claim 41 wherein the computer-readable code is further configured to cause a computer processor to store on the computer-readable medium the received one or more configuration selections as the set of instrument configuration control information.

45. The computer program product of claim 44 wherein the computer-readable code configured to cause a computer processor to store on the computer-readable medium the received one or more configuration selections as the set of instrument configuration control information is further configured to cause a computer processor to store the set of instrument configuration control information on a transportable computer-readable medium.

46. The computer program product of claim 41 wherein the computer-readable code is further configured to cause a computer processor to store on a computer-readable medium the set of configuration selections as the set of instrument configuration control information.

47. The computer program product of claim 46 wherein the computer-readable code that is configured to cause a computer processor to store the set of instrument configuration control information is further configured to cause a computer processor to store the set of instrument configuration control information as a function of a security code.

48. The computer program product of claim 40 wherein the computer-readable code configured to cause a computer processor to configure a plurality of operational and display configuration options of an avionics instrument as a function of the retrieved set of instrument configuration control information further comprises computer-readable code configured to cause a computer processor to configure one or more of an appearance and a presentation of situational awareness information displayed on the avionics device.
